(19) United States
(12) Patent Application Publication
(10) Pub. No.: US 2020/0340429 A1
(43) Pub. Date: Oct. 29, 2020

(54) EFFICIENCY AND EMISSIONS IMPROVEMENTS FOR NATURAL GAS CONVERSIONS OF EMD 2-CYCLE MEDIUM SPEED ENGINES

(71) Applicant: Clean Train Propulsion, Fullerton, CA (US)

(72) Inventor: David Cook, Fullerton, CA (US)

(21) Appl. No.: 16/765,155

(22) PCT Filed: Nov. 19, 2018
(86) PCT No.: PCT/US2018/061892

§ 371 Date: May 18, 2020

Related U.S. Application Data
(63) Continuation of application No. 15/816,830, filed on Nov. 17, 2017, now Pat. No. 10,385,807.

(51) Int. Cl. F02M 21/02

(52) U.S. Cl. CPC F02M 21/0251; Y02T 10/32; F02M 21/0209; F02M 21/0269

(57) ABSTRACT

A prechamber assembly includes a prechamber combustion volume located within a cylinder head, wherein the prechamber combustion volume includes a wall extending between a first end and a second end and a prechamber axis, an injector including a fuel passage in communication with the first end of the prechamber combustion volume, a throat in communication with the second end of the prechamber combustion volume, wherein the throat includes a throat axis extending between the prechamber combustion volume and a plurality of jets, and wherein the throat axis and the prechamber axis form an angle.

### CROSS-REFERENCE TO RELATED APPLICATIONS

This application comprises a national stage entry of International Application No. PCT/US2018/061892 filed Nov. 19, 2018, claiming the benefit of priority to U.S. application Ser. No. 15/816,830 filed Nov. 17, 2017, each disclosure of which is incorporated by reference herein.

### BACKGROUND OF THE INVENTION

When supplemental fuel is injected into a prechamber in order to richen the mixture of air and fuel in the prechamber, mixing of the supplemental fuel with the incoming lean main chamber air/fuel mixture is important to ensuring stable combustion in the prechamber. For gaseous fuels injected at pressures below 100psi this is even more of a challenge over liquid fuels injected at the same or higher pressure. Because of the tight packaging for most prechambers and the need for both a spark plug and a fuel port, a standard prechamber nozzle main orifice that injects the combustion chamber air and fuel along the combustion chamber axis will cause internal recirculation that will mix the fuel and air on the side of the chamber that it was injected on whereas the spark plug side of the prechamber could be left leaner than it would be if the mixture of supplemental fuel and incoming main chamber lean air/fuel mixtures was well distributed. If the mixture directly in the vicinity of the spark plug is not rich enough, the prechamber could misfire. Overcoming poor mixture in the prechamber could require adding more supplemental fuel than needed to the prechamber. While this excess fuel might leave an ignitable mixture of air and fuel near the spark plug, other parts of the prechamber can end up too rich resulting in incomplete combustion in the prechamber resulting in lower prechamber pressure and energy and higher hydrocarbon emissions from the engine.

Prechambers are typically manufactured in at least 2 parts, a main body and a welded on nozzle. Prechamber nozzles are usually cylindrical in shape and have jets located radially. This leads to economical manufacture on lathe machinery along an axis of symmetry.

### BRIEF SUMMARY OF THE INVENTION

Proposed here is a prechamber nozzle feature that redirects the incoming prechamber flow of main chamber air and fuel angled away from the prechamber axis to assert an in initial angular incoming flow and resulting swirling flow across the top of the prechamber volume.

This summary is most closely related to the use of a mixture of air and fuel as the medium injected as supplemental fuel into a prechamber.

When supplemental fuel is injected into a prechamber in order to richen the mixture of air and fuel in the prechamber, mixing of the supplemental fuel with the incoming lean main charge is important to insuring stable combustion in the prechamber. For gaseous fuels injected at pressures below 50psi this is even more of a challenge over liquid fuels injected at the same or higher pressure. The increased injection volume afforded by the additional air adds several beneficial effects.

Increased mass flow allows increasing the fuel injection passage size reducing flow variations due to tolerance effects. In one truck engine system, the fuel passage was only 0.032 inches in diameter.

If an independent injector is used for each prechamber, this increased mass flow allows increasing the size of the injector with the same benefits of the passage size improvement above

Increased mass flow allows operating at higher pressure deltas increasing penetration and mixing of the injected supplemental fuel with the incoming air and fuel from the main chamber

Increased injected volume improves scavenging reducing the amount of residual combustion byproducts left over in the prechamber combustion volume from the previous cycle.

Especially beneficial for prechambers used with stoichiometric air fuel ratios and cooled EGR as there is no excess oxygen available in the main charge for any supplemental fuel added to the prechambers to mix and combust with.

### DESCRIPTION OF THE DRAWINGS

FIG. 1 is a section view of a truck engine cylinder head with an installed prechamber assembly and a piston.

FIG. 2 is a section view of a prior art prechamber with a conventional straight throat.

FIG. 3 is a section view of a prechamber assembly with an angled throat to improve prechamber mixing of supplemental fuel with incoming main chamber lean mixture of air and fuel.

### DETAILED DESCRIPTION

To facilitate an understanding of the present disclosure, a number of terms and phrases are defined below:

Gaseous Fuel: The predominant gaseous fuel used in internal combustion engines is natural gas consisting mostly of methane, but with minor modifications these engines could consume any gaseous fuel including but not limited to propane, natural gas and hydrogen. In this document the term natural gas and gaseous fuel are used interchangeably.

Hydrocarbon (HC): Emissions resulting from incomplete combustion.

Main Charge: The air fuel mixture in the main combustion chamber space between the piston top and the cylinder head. If an opposed piston engine, this would be the space between the opposed piston faces.

Particulate Matter (PM): Particulate matter is a criteria pollution emitted from many sources. In this document we will commonly refer to it simply as PM. It could include both diesel soot PM that is considered toxic in California or the type of PM created by the consumption and combustion of lube oil from an engine. While still considered PM as a criteria emission, the PM from lube oil consumption is considered less toxic than diesel soot.

The present application discloses a prechamber assembly with a tilted throat used to improve the internal mixing of the supplemental fuel with the incoming very lean main charge.

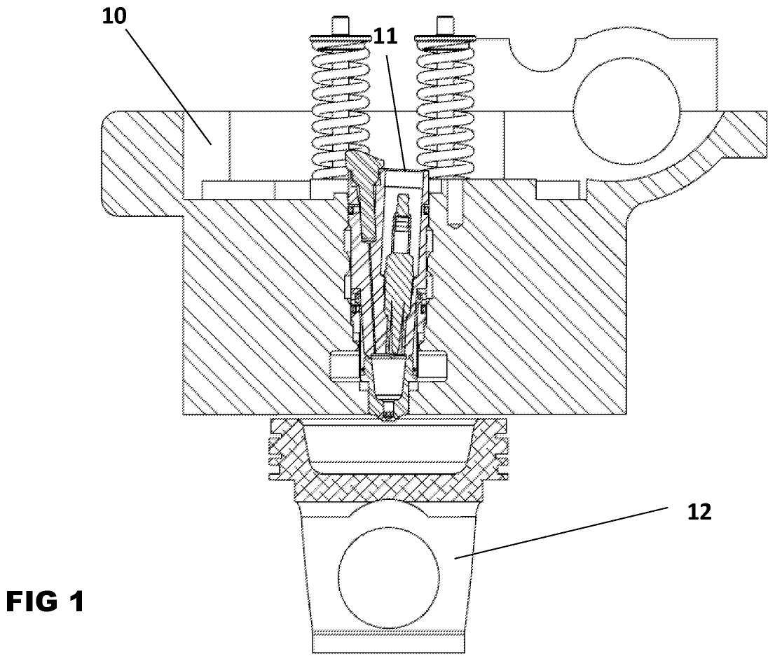

FIG. 1 is a section view of a typical of a class 8 truck cylinder head 10 with a piston 12 and prechamber assy 11. In this case piston 12 is a low compression piston with a compression ratio of 10.5 to 1.

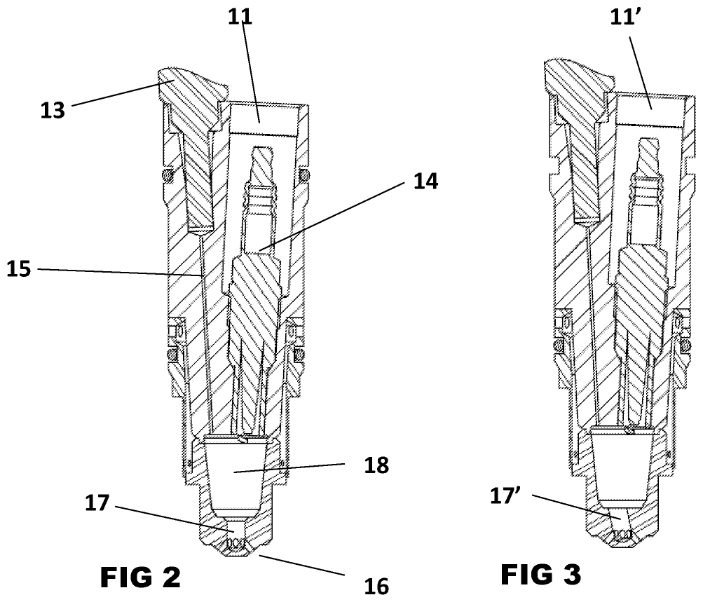

FIG. 2 is a section view of a prior art prechamber assy 11. Injector 13 is used to control the flow of supplemental fuel through fuel passage 15 into the prechamber combustion volume 18. Spark Plug 14 is used to ignite the air and fuel mixture within the prechamber combustion volume 18. The rapidly burning air and fuel mixture generates high temperature and pressure within the prechamber combustion volume 18 forcing hot burning combustion by-products to pass through the throat 17 and then through one of the multiple jets 16. It is the high velocity burning jets of combusting air and fuel exiting the multiple jets 16 that create multiple ignition sites in the engine cylinder main chamber between cylinder head 10 and piston 12. FIG. 1 makes it apparent that the fuel passage 15 and spark plug 14 are on opposite sides of the prechamber axis. During the compression stroke of the engine cylinder while piston 12 is moving vertically along the cylinder towards head 10, increased pressure will cause main charge to flow through jets 16 combining in throat 17 and flowing through throat 17 into the prechamber combustion volume 18. In the prior art prechamber assembly 11 throat 17 is aimed along the axis of the prechamber which will cause the incoming main charge to flow along the axis into the prechamber aimed at a point inbetween spark plug 14 and fuel passage 15. Because of this the incoming supplemental fuel that is injected through supplemental fuel passage 15 is likely to be mixed with a portion of the incoming main charge that swirls on the left side of the prechamber combustion volume 18. Another portion of incoming main charge will swirl on the opposite side where spark plug 14 is. This axial flow of the incoming main charge prevents most of the supplemental fuel from enriching the air fuel ratio near the spark plug making it a challenge for spark plug 14 to ignite the air fuel mixture at its electrode where the spark will occur because it is closer to the air fuel ratio of the main charge.

FIG. 3 is a section view of prechamber assembly 11′ which is manufactured with a throat 17′ which is not in line with the axis of the prechamber assembly 11′. In this case the axis of the throat is angled towards the prechamber combustion volume 18 wall to the left of where fuel passage 15 enters. In this case the incoming main charge will now have to swirl from left to right bringing the supplemental fuel with the main charge across the area where spark plug 14 will ignite the mixture. Now that the main charge is mixed with the supplemental fuel it should be closer to a stoichiometric mixture which would make ignition of the mixture more likely by spark plug 14. The more thorough mixture of supplemental fuel and main charge throughout the prechamber combustion volume 18 will create a faster burn rate and higher pressure within the prechamber combustion volume 18 creating faster and more thorough combustion in the main chamber between head 10 and piston 12.

In a further embodiment, a mixture of fuel and air is injected into a prechamber to improve mixing and scavenging. Referring to an alternate embodiment injector 11 in FIG. 2, injector 13 may be used to inject a mixture of air and fuel instead of fuel only as in prior art prechamber systems. When an engine is operating at low loads, only a small amount of supplemental fuel is required to be injected into the prechamber combustion volume 18. As this volume gets smaller, the either the injection duration or injection pressure must drop to reduce the flow. Losing either injection duration or injection pressure will reduce the amount of mixing that the injected supplemental fuel does with the incoming main charge. One way to increase the duration or pressure of injection is to also inject air with the fuel to increase the total volume injected. This not only increases internal mixing, but the increased volume of injected air and fuel will also help push out any remaining combustion byproducts still in the prechamber combustion volume 18 from the previous cycle.

In another embodiment injector 13 is replaced with a simple check valve, this is common for prechamber systems on large 2-stroke engines. With the use of check valve in place of injector 13 there is no control over injection duration so at low supplemental fuel flows the injection pressure will drop significantly. This mixing of air and supplemental fuel in the check valve case is even more beneficial as injection pressure drops so low that the supplemental fuel may pool at the top of the prechamber combustion volume making internal mixing even more of a challenge.

I claim:

1. A prechamber assembly comprising:
a prechamber combustion volume located within a cylinder head, wherein the prechamber combustion volume includes a wall extending between a first end and a second end and a prechamber axis;
an injector including a fuel passage in communication with the first end of the prechamber combustion volume;
a throat in communication with the second end of the prechamber combustion volume, wherein the throat includes a throat axis extending between the prechamber combustion volume and a plurality of jets;
wherein the throat axis and the prechamber axis form an angle.

2. The prechamber assembly of claim 1, wherein the throat axis forms an acute angle with the prechamber axis.

3. The prechamber assembly of claim 1, wherein the throat axis is angled toward the wall of the prechamber.

4. The prechamber assembly of claim 1, further comprising
a spark plug in communication with the first end of the prechamber combustion volume on a first side of the prechamber axis, wherein the fuel passage of the injector is on a second side of the prechamber axis;
wherein the throat axis is angled toward the first side of the prechamber axis.

5. The prechamber assembly of claim 4, wherein the throat axis is directed toward the wall adjacent to the fuel passage.

6. The prechamber assembly of claim 5, wherein the throat axis is directed toward the wall adjacent to the fuel passage opposite the spark plug.

7. The prechamber assembly of claim 1, wherein the wall of the prechamber combustion volume is symmetrical along the prechamber axis.

8. The prechamber assembly of claim 7, wherein the wall of the prechamber combustion volume is annular.

9. The prechamber assembly of claim 1, wherein the injection includes a supplemental fuel for injecting into the prechamber combustion volume through the fuel passage.

10. The prechamber assembly of claim 9, wherein the supplemental fuel includes a fuel and air.
